(19) United States
(12) Patent Application Publication
(10) Pub. No.: US 2007/0280203 A1
(43) Pub. Date: Dec. 6, 2007

(54) Method and System for Managing a Plurality of Virtual Talk Groups

(76) Inventors: Shmuel Shaffer, Palo Alto, CA (US); Shah Talukder, Los Gatos, CA (US); Kittur V. Nagesh, Saratoga, CA (US); Laurent F. Philonenko, San Francisco, CA (US); Douglas J. Hall, Westerville, OH (US); Yogesh Kalley, Sunnyvale, CA (US)

Correspondence Address: BAKER BOTTS L.L.P., 2001 ROSS AVENUE, SUITE 600, DALLAS, TX, 75201-2980, US

(21) Appl. No.: 11/421,999

(22) Filed: Jun. 2, 2006

(51) Int. Cl. H04L 12/66; H04L 12/56

(52) U.S. Cl. 370/352; 370/401

(57) ABSTRACT

A method for managing a plurality of virtual talk groups includes forming a first virtual talk group associated with a first endpoint. The first virtual talk group includes the first endpoint and a second endpoint. The second endpoint is associated with a first function. The method also includes facilitating communications between the endpoints of the first virtual talk group. The method also includes, upon a change in a function of the first endpoint from the first function to a second function, receiving a request to add a third endpoint to the first virtual talk group. The third endpoint is associated with the second function. The method also includes adding the third endpoint to the first virtual talk group and removing the second endpoint from the first virtual talk group after the third endpoint has been added to the first virtual talk group for a first amount of time.

### TECHNICAL FIELD OF THE INVENTION

This invention relates in general to communication systems and, more particularly, to a method and system for managing a plurality of virtual talk groups.

### BACKGROUND OF THE INVENTION

Pilots as well as many public and private groups, such as security and safety personnel (e.g., police, firefighters and ambulance drivers) use various different types of communication devices operating on various different communication networks. Many networks utilize land mobile radios communicating through push-to-talk technologies. However, communications among different endpoints of different networks such as endpoints of different police, fire or other security networks may present a challenge. Collaboration between the different agencies and networks tends to be ad hoc and inefficient. When achieved, it often involves laborious manual intervention. Moreover, while users within particular functional groups (e.g., baggage handlers or security personnel) may use a single radio frequency as they carry out their duty, a pilot may have to switch between multiple radio frequencies as he progresses through the various operational functions and stages an airplane goes through in preparing for and conducting a flight. Organizations working towards interoperability solutions include Raytheon JPS Communications, Motorola, European Aeronautic Defense and Space Co (EADS), IP Blue, Twisted Pair, M/A-COM and Cisco Systems.

### SUMMARY OF THE INVENTION

The present invention provides a method and system for managing a plurality of virtual talk groups that substantially eliminates or reduces at least some of the disadvantages and problems associated with previous methods and systems.

In accordance with a particular embodiment, a method for managing a plurality of virtual talk groups includes forming a first virtual talk group associated with a first endpoint. The first virtual talk group includes the first endpoint and a second endpoint. The second endpoint is associated with a first function. The method also includes facilitating communications between the endpoints of the first virtual talk group. The method also includes, upon a change in a function of the first endpoint from the first function to a second function, receiving a request to add a third endpoint to the first virtual talk group. The third endpoint is associated with the second function. The method also includes adding the third endpoint to the first virtual talk group and removing the second endpoint from the first virtual talk group after the third endpoint has been added to the first virtual talk group for a first amount of time.

In particular embodiments the method may include facilitating communications between the endpoints of the first virtual talk group by facilitating communications of the first virtual talk group to the first endpoint through a first communication channel associated with the first endpoint.

In some embodiments the request to add the third endpoint to the first virtual talk group may be received from the second endpoint. In particular embodiments receiving the request to add a third endpoint to the first virtual talk group may include receiving a change in a location parameter of the first endpoint. The change in the location parameter of the first endpoint may correspond to the change in the function of the first endpoint.

In particular embodiments removing the second endpoint from the first virtual talk group after the third endpoint has been added to the first virtual talk group for a first amount of time may include receiving from the third endpoint a request to remove the second endpoint from the first virtual talk group. In some embodiments the first endpoint may be a pilot of an airplane, the second endpoint may be an airport dispatcher and the third endpoint may be an air traffic controller. The method may further include alerting the first endpoint that the third endpoint will be added to the first virtual talk group and that the second endpoint will be removed from the first virtual talk group.

In accordance with another embodiment a system for managing a plurality of virtual talk groups includes a processor operable to form a first virtual talk group associated with a first endpoint. The first virtual talk group includes the first endpoint and a second endpoint. The second endpoint is associated with a first function. The processor is also operable to facilitate communications between the endpoints of the first virtual talk group. The system may also include an interface coupled to the processor and operable to, upon a change in a function of the first endpoint from the first function to a second function, receive a request to add a third endpoint to the first virtual talk group. The third endpoint is associated with the second function. The processor is further operable to add the third endpoint to the first virtual talk group and remove the second endpoint from the first virtual talk group after the third endpoint has been added to the first virtual talk group for a first amount of time.

Technical advantages of particular embodiments include systems and methods for providing interoperable communications among endpoints of various types that utilize differing communication networks. Virtual talk groups may be created dynamically to enable communication between an endpoint that, at different times, needs to communicate with different groups of endpoints, such as an airplane, and endpoints performing particular functions, such as those endpoints responsible for refueling an airplane or directing air-traffic. Particular embodiments allow for one or more of the endpoints within one virtual talk group to be transferred to a different virtual talk group as the function they need or are providing changes. Accordingly, a user is always in the appropriate virtual talk group based on their needed function. Particular embodiments may cause an endpoint to be added to a virtual talk group based on the location of another endpoint. Some embodiments allow a different user to add an endpoint to the virtual talk group. Accordingly, a pilot of an airplane, for example, is able to proceed through the various stages of preparing for a flight, flying, and concluding the flight, without having to constantly change his radio channel. Some embodiments may alert an endpoint before there is a change in which endpoints with which he is able to communicate. Accordingly, the endpoint is made aware of changes that are about to take place and has an opportunity to cancel or override the transfer.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a communication system with various communication networks and an interoperability system, in accordance with a particular embodiment;

FIG. 2 illustrates an example interoperability system, in accordance with a particular embodiment;

FIG. 3 illustrates an example airport in which the interoperability system of FIG. 2 may be used in accordance with a particular embodiment; and

FIG. 4 illustrates a method for managing a plurality of virtual talk groups.

### DETAILED DESCRIPTION

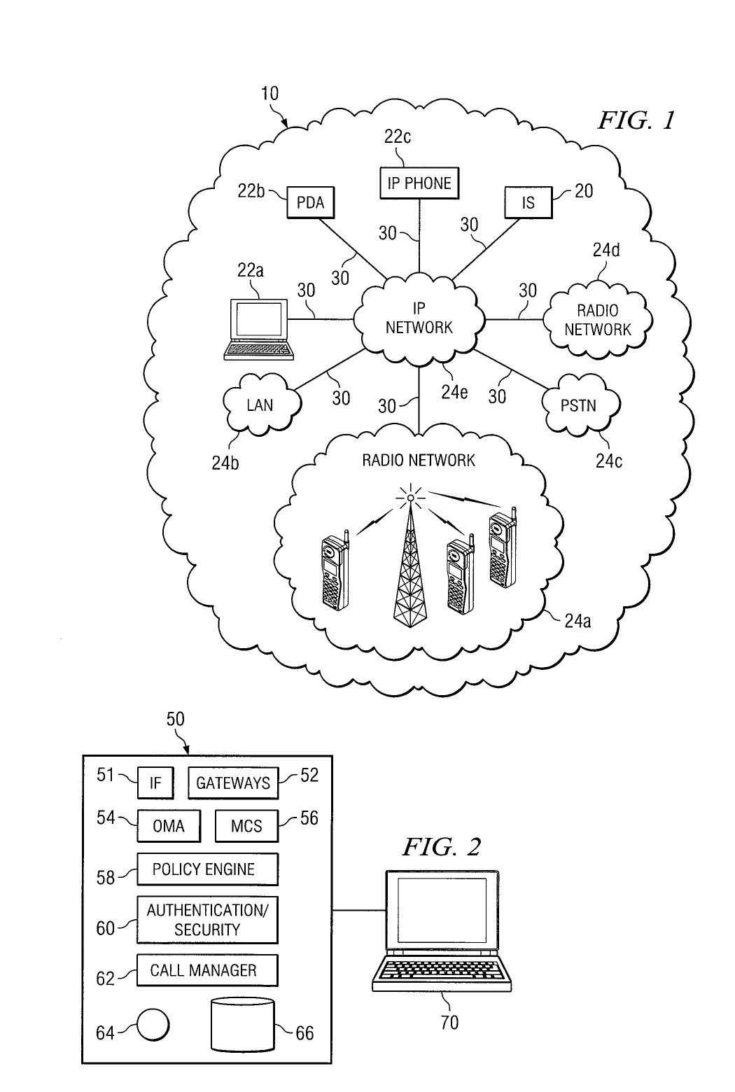

FIG. 1 illustrates a communication system 10, in accordance with a particular embodiment. Communication system 10 includes communication networks 24a-24e, interoperability system (IS) 20 and endpoints 22a-22c. IS 20 is able to facilitate interoperable communication sessions between and among various communication devices, such as endpoints of communication networks 24 and endpoints 22. IS 20 uses a systems approach to offer a framework based on IP protocols and services to facilitate secure voice, video and other data interoperability among communication endpoints and networks utilizing different technologies.

Because of the complexities of an airport, such as the wide variety of users and the close relationship between a user and his or her endpoint it may be beneficial to list upfront how different terms may be used interchangeably. The terms “endpoint,” “airplane,” “communication device,” “baggage handler,” “user,” “pilot,” “dispatcher,” and “controller” may be used interchangeably to refer to either the device transmitting the communication and/or to the user of the device, as appropriate. The terms “dispatcher,” “operator,” and “controller” may be used interchangeably to refer to a user who has administrative control of an IS.

In particular embodiments, for example at an airport, it may be desirable to have virtual talk groups that are associated with different airplanes around the airport. The virtual talk groups may include those endpoints with which the airplane may need to communicate, for example, those endpoints responsible for loading the airplane and preparing it for a flight. The endpoints assigned to a particular virtual talk group are able to communicate with one another regardless of the type of communication device they are using. In many instances, the function of an endpoint (e.g., a pilot) from one virtual talk group may change. As the endpoint's needs change the endpoints assigned to his VTG may also change. By changing which endpoints are assigned to a particular VTG it is possible to change with whom the pilot is able to communicate without the pilot having to adjust his communication device, for example, by changing his radio frequency (RF) channel. In some embodiments endpoints may automatically be added to the virtual talk groups. In some embodiments a different endpoint, for example a traffic controller or dispatcher, may add the endpoints to the virtual talk groups.

In the illustrated embodiment, communication networks 24a and 24d comprise radio networks (RNs), communication network 24b comprises a local area network (LAN), communication network 24c comprises a public switched telephone network (PSTN) and communication network 24e comprises an IP network. It should be understood, however, that communication system 10 may comprise any number of IP or non-IP communication networks of any wireless or wireline form capable of communicating audio and/or video telecommunication signals, data, and/or messages, including signals, data or messages. Communication networks 24a-24e may include any number and combination of segments, nodes and endpoints to enable communication among network devices and components. Communication networks 24a-24e may be distributed locally or across multiple cities and geographic regions. Nodes may include any combination of network components, gatekeepers, call managers, conference bridges, routers, hubs, switches, gateways, base stations, endpoints or other hardware, software or embedded logic implementing any number of communication protocols that allow for the exchange of data in communication system 10. Segments 30, which may comprise any suitable wireless or wireline communication links, including one or more communication networks (e.g., WANs) as appropriate, couple various networks with each other and with endpoints 22 and IS 20. In particular embodiments, segments 30 may include gateways for facilitating communication between various networks, such as a land mobile radio (LMR) gateway between radio network 24a and IP network 24e.

In some cases, endpoints of one of communication networks 24a-24e may communicate with endpoints of another of communication networks 24a-24e through IS 20. A radio network, such as radio network 24a or 24d, may support communication among portable mobile station endpoints, such as land mobile radios (LMRs), using any suitable communication methods or features, such as cellular and push-to-talk (PTT). Communication networks 24a-24e may comprise networks of particular groups or agencies (e.g., an airport's luggage handlers or a municipality's police department).

IS 20 enables, facilitates and/or provides for interoperable communication among communication endpoints and devices, such as LMRs, cellular phones, IP phones, PCs, PDAs, PSTN phones, video monitors, cameras and sensors of one or more communication networks (e.g., communication networks 24a-24e) using Internet Protocol. Such endpoints may comprise IP or non-IP-enabled endpoints. In particular embodiments, IS 20 may control gateways (for example, of segments 30) in order to map radio frequencies of particular mobile radio endpoints to IP addresses for communication to other types of radio endpoints or IP devices. For example, a particular gateway may be able to receive communications from various types of endpoints (e.g., on various types of communication networks) and may convert such communications for transmission to other types of endpoints. IS 20's control of the gateway may control the various endpoints and/or networks that receive particular communications, depending on system functionality and configuration as further discussed below. As indicated, such control may include the mapping of communications and endpoints to IP addresses for interoperable communication. In some embodiments, IS 20 may host audio conferences that bridge communications received from endpoints. As indicated above, communication system 10 (including IS 20) may include any suitable number or type of gateways (e.g., LMR and PSTN gateways), servers (e.g., multipoint conference servers), switches, routers, firewalls, access points, processors, memory or other hardware, software or encoded logic to provide functionality described herein. IS 20 is coupled to communication networks 24a-24d and endpoints 22 through IP network 24e, which may comprise any suitable IP network.

As indicated above, IS 20 uses IP to enable communication among endpoints of various networks. The manner in which IS 20 facilitates communications among endpoints may vary according to location and system or operational needs. For example, IS 20 may communicate with endpoints using multicast IP addresses assigned to an endpoint of a communication network, a group of endpoints of a communication network or one or more endpoints of multiple communication networks or alternatively using a peer to peer dialed connection or a nailed dialed connection. A group of endpoints may be combined into a virtual talk group for communication using a particular IP address. As an example, the virtual talk group may be assigned a multicast IP address through which various endpoints may communicate via the talk group. The use of multicast IP addresses allows IS 20 to facilitate communications among communication devices and endpoints of various communication networks to provide audio, data, video and control network interoperability. As an additional example, in some cases multicast streams (e.g., utilizing multicast IP addresses) may be used. In some cases nailed dialed connections, such as those using SIP protocol, may be used for communication among endpoints and with IS 20. Various embodiments may combine communication methods to facilitate communication among endpoints. For example, in some cases certain endpoints of a virtual talk group may participate in the talk group through a multicast IP address while other endpoints may utilize a nailed SIP connection. IS 20 may control this participation, such as by controlling gateways, multipoint conferences and the mapping of communications to IP addresses.

IS 20 may be utilized and implemented in any number of market segments, such as airports, docks, enterprise safety and security (e.g., loss prevention), transportation, retail, public safety and federal agencies in order to provide radio and non-radio network interoperability within and between such market segments. As indicated above, such network interoperability includes the interoperability of push-to-talk voice technology within various networks and the interoperability between push-to-talk and full duplex dialed connections.

It will be recognized by those of ordinary skill in the art that endpoints 22 and IS 20 may be any combination of hardware, software, and/or encoded logic that provides communication services to an endpoint. In the illustrated embodiment, endpoints 22 comprise a PC (endpoint 22a), a PDA (endpoint 22b) and an IP phone 22c). However, in other embodiments, endpoints 22 may include a telephone, a computer, a video monitor, a camera, a cell phone, a land mobile radio (LMR), a command center, or any other communication hardware, software and/or encoded logic that supports the communication of audio, video or other data through communication system 10. Endpoints 22 as well as endpoints and components of communication networks 24 may be capable of communicating using any particular type of technology, such as cellular, IP, PSTN, CDMA, GSM, TDMA and satellite. Endpoints 22 and IS 20 may also include unattended or automated systems, gateways, other intermediate components or other devices that can establish media sessions.

Although the illustrated embodiment includes five communication networks 24a-24e, the term “communication network” should be interpreted as generally defining any network capable of transmitting audio and/or video telecommunication signals, data, and/or messages, including signals, data or messages. Any one of networks 24a-24e may be implemented as a local area network (LAN), wide area network (WAN), cellular network, global distributed network such as the Internet, Intranet, Extranet, PSTN, LMR network, CDMA network, GSM network, TDMA network, satellite network or any other form of wireless or wireline communication network.

Communications over communication networks 24a-24e may use any suitable communication protocol. In a particular embodiment, some communication networks may employ voice communication protocols that allow for the addressing or identification of endpoints, nodes, and/or other components coupled to the communication network. For example, using Internet protocol (IP), each of the components coupled together by, for example, communication network 24b in communication system 10 may be identified in information directed using IP addresses. In this manner, network 24b may support any form and/or combination of point-to-point, multicast, unicast, or other techniques for exchanging media packets among components in communication system 10. Any network components capable of exchanging audio, video, or other data are included within the scope of the present invention.

Since IP networks share a common method of transmitting data, telecommunication signals may be transmitted between telephony devices located on different, but interconnected, IP networks. In addition to being coupled to other IP networks, communication network 24b may also be coupled to non-IP telecommunication networks, for example through the use of interfaces or components, including gateways. In the illustrated embodiment, communication network 24b may be coupled with PSTN 24c through a gateway. In some embodiments the gateway may be a part of IS 20 or network 24e. PSTN 24c includes switching stations, central offices, mobile telephone switching offices, pager switching offices, remote terminals, and other related telecommunications equipment that are located throughout the world. IP networks transmit data (including voice and video data) by placing the data in packets and sending each packet individually to the selected destination, along one or more communication paths. Unlike a circuit-switched network (like PSTN 24c), a dedicated circuit is not required for the duration of a call or fax transmission over IP networks.

Technology that allows telecommunications to be transmitted over an IP network may comprise Voice over IP (VoIP), or simply Voice over Packet (VoP). In the illustrated embodiment, one or more of endpoints 22, and endpoints and components of communication networks 24 may be IP telephony devices capable of participating in IM, video, and other multimedia communication sessions. IP telephony devices have the ability to encapsulate a user's voice (or other input) into IP packets so that the voice can be transmitted over a communication network. IP telephony devices may include telephones, fax machines, computers running telephony software, nodes, gateways, wired or wireless devices, hand held PDAs, or any other device capable of performing telephony functions over an IP network.

In particular embodiments, communication system 10 may receive and transmit data in a session initiation protocol (SIP) environment. SIP is an application-layer control protocol that includes primitives for establishing, modifying and terminating communication sessions. SIP works independently of underlying transport protocols and without dependency on the type of session that is being established. SIP also transparently supports name mapping and redirection services, which support personal mobility.

Although FIG. 1 illustrates a particular number and configuration of endpoints, IS and communication networks, communication system 10 contemplates any number or arrangement of such components for communicating media.

FIG. 2 illustrates interoperability system (IS) 50, in accordance with a particular embodiment. IS 50 may be similar to and provide the same functionality as IS 20 of FIG. 1. In the illustrated embodiment, IS 50 includes interface 51, gateways 52, operations management application (OMA) 54, multipoint conference system (MCS) 56, policy engine 58, authentication and security system 60, call manager 62, processor 64 and memory module 66. IS 50 is coupled to a PC endpoint 70 that may be used to access, configure and control various functionality provided by IS 50. PC endpoint 70 may run a client application for such access, configuration and control. The client application may enable endpoint 70 to receive and monitor communications from various endpoints and virtual talk groups (VTGs). In particular embodiments, other types of endpoints may be utilized to access, configure and control IS 50, such as IP phones, PDAs and mobile devices. IS 50 may be coupled to such endpoints (including PC endpoint 70) through one or more communication networks.

Interface 51 is used in the communication of audio, video, signaling and other data between IS 50 and other network components. For example, interface 51 may receive communications from endpoint 70. The communication may take place over IP networks thereby negating the need for dedicated wiring between the endpoints and the IS.

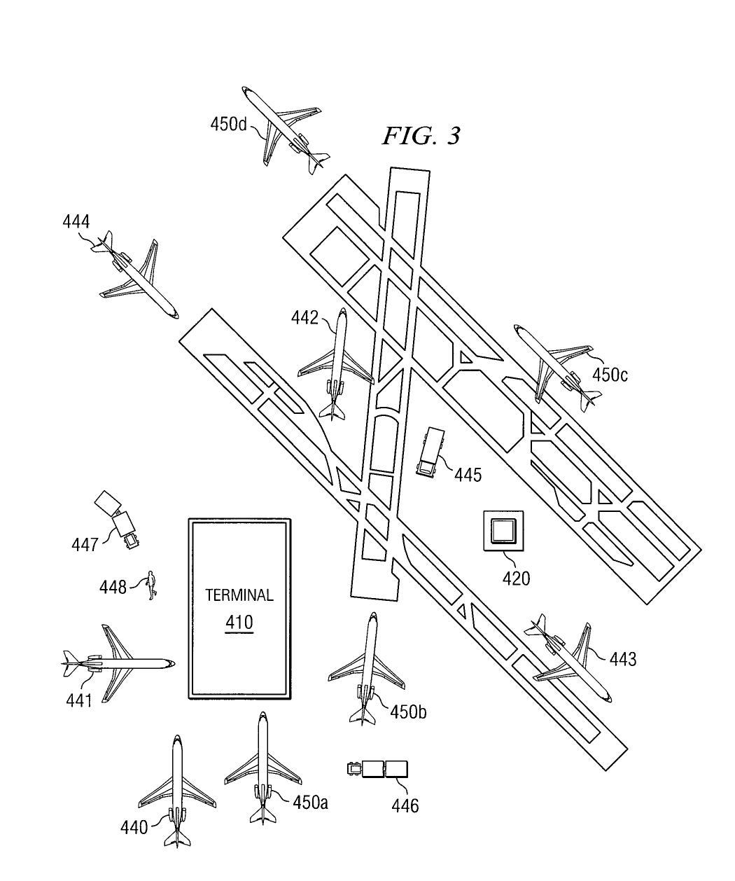

Gateways 52 may include any suitable gateways to provide network interoperability and back-end legacy application integration, such as LMR gateways, PSTN gateways and application gateways. Gateways 52 provide mapping between IP services and the interoperable networks, such as LMR network 24a of FIG. 1. In some cases gateways 52 may not be located within an IS but may be distributed throughout a communication system for enabling communications among various communication networks. For example, in some embodiments endpoints, such as airplane 440 of FIG. 3, may include an LMR gateway that may allow the endpoint to function as an IP endpoint.

Operations management application (OMA) 54 includes functionality for configuration, management and control of IS 50, including conference and collaboration management, and may be accessed by a user via, for example, PC endpoint 70. In particular embodiments, OMA 54 may enable users, such as dispatch personnel, administrators or air traffic controllers accessing IS 50, to configure, manage and participate in one or more VTG and ad hoc conferences simultaneously. In particular embodiments, OMA 54 may be accessed through a web interface, functioning for example as a soft phone for radios. A screen display may be controlled using a mouse, keypad, touch screen, voice commands or any other suitable interface. OMA 54 screens may include any number of functional controls to provide interoperable communications. OMA 54 may authenticate a user and obtain user configuration information upon a user accessing the OMA. OMA 54 may monitor and provide communication ability for any number of channels at one time to provide the ability for an OMA user to communicate on and control multiple VTGs at once.

Multipoint conference system (MCS) 56 provides collaboration and conference services for multiple endpoints of one or more networks. For example, users of multiple endpoints (such as LMRs of different networks (e.g., networks of different functional groups) and different types of endpoints of different networks) may be bridged together through MCS 56 to provide VTG communications. MCS 56 may include any suitable number or type of conference bridges, ports, digital signal processors or other components to facilitate communications discussed herein.

Policy engine 58 includes policies for undertaking various operations and functionality upon the occurrence of various events to provide dynamic incident management. These policies may include both pre-determined and ad hoc policies. For example, upon the occurrence of a particular event, the event may include a unique identifier and may have basic event attributes such as time of creation, name of user creating, location of event and status. A pre-determined policy may then be executed by a function manager or dispatch personnel as action for the specific event. In particular embodiments, policy engine 58 may receive inputs from alarms and sensors to set up device diagnostic communications interoperability and one-way video and data collaboration and to trigger additional events such as pagers, e-mails, notifications, dial-outs, recording and information escalation. Additionally, policy engine 58 may be used to determine how and when a particular endpoint is to be added to a VTG. For example, in an airport setting policy engine 58 may determine if and when a towing vehicle is to be added to an airplane's VTG, and if and when it is going to be removed from the airplane's VTG. Policy engine 58 may also determine how long multiple dispatchers may be associated with the same airplane's VTG (e.g., how long an old dispatcher remains in the VTG after the new dispatcher has been successfully added).

Authentication and security system 60 manages access, configuration and control privileges for endpoints of IS 50 and those participating in interoperable communications. For example, different endpoints may have different privileges assigned for interoperable communications. Some endpoints may only have transmit or listen privileges with respect to one or more particular talk groups, while other endpoints may have the ability to communicate in all talk groups or setup and configure various talk groups. Endpoint privileges may change dynamically upon the occurrence of particular events such as where the endpoint changes location or otherwise changes function.

Call manager 62 maintains information regarding various users/endpoints, such as users of IP networks for which interoperable communications are provided by IS 50. This facilitates in the extension of PTT to IP networks and in the provision of voice and data interoperability across radio and non-radio networks. In particular embodiments, call manager 62 may maintain a listing, table, or other organization of information about users. The information may include a name or other identifier and contact information such as phone numbers and email addresses for the users. In particular embodiments call manager 62 may represent any appropriate combination of hardware, software and/or encoded logic distributed throughout a communication network coupled with an IS.

Processor 64 may be a microprocessor, controller, or any other suitable computing device, resource, or combination of hardware, software and/or encoded logic operable to provide, either alone or in conjunction with other IS components such as OMA 54, IS 50 functionality. Such functionality may include providing various features discussed herein to a user, such as a user of an endpoint accessing IS 50 through OMA 54. Such features may include determining which endpoints are part of which VTGs, determining when a particular endpoint should be added to or removed from a VTG, enabling a dispatcher or controller to listen to and/or participate in communications involving endpoints and/or VTGs associated with different functions, presenting communications of endpoints of particular VTGs according to preconfigured or received instructions and controlling various gateways and other network components to facilitate interoperable communications among various endpoints.

Memory module 66 may be any form of volatile or non-volatile memory including, without limitation, magnetic media, optical media, random access memory (RAM), read-only memory (ROM), removable media, or any other suitable local or remote memory component. Memory module 66 may store any suitable data or information, including software and encoded logic, utilized by IS 50. In particular embodiments, memory module 66 may include data for endpoint management, talk-group management, resource pool management, privileges, backup configuration and information and/or timestamp and activity tracking.

IS 50 may also include any number of switches, routers, firewalls, mobile access routers, access points, wireless bridges and other components in order to accommodate particular operational desires and needs.

In particular embodiments such as in the LMR network interoperability context, IS 50 may, through one or more components discussed above or through other components, encode received audio with a standard audio codec, such as G.711 or G.729. Those audio samples may be packaged in standards-based real-time transport protocol (RTP) or real-time transport control protocol (RTCP) packets suitable for transport on an IP network. At this point, the communication element may be abstracted from the distinctive characteristics of each radio system. These audio packets can be sent across the network to other radio systems either individually (unicast) or as a group (multicast). The recipient of the audio packets may be a device capable of receiving and decoding the RTP or RTCP stream, such as an IP telephone or PC with appropriate software. The IP network and IP-enabled devices can be used to allow endpoints to monitor or transmit on a particular radio channel from a desk without issuing another radio.

As indicated above, IS 50 may facilitate communication among endpoints of various networks through virtual channels or talk groups. For example, a channel may comprise a unidirectional or bidirectional path for transmitting and/or receiving electrical or electromagnetic signals. This may comprise, for example, a conventional radio physical RF channel. A talk group in this context may be a subgroup of users who share a common functional responsibility and typically coordinate their actions amongst themselves without communicative interaction with other subgroups. For example, an airport's security force network may include various endpoints that do not usually require radio connectivity with other functional groups (e.g., baggage handlers) but who are in constant communication amongst themselves, whether by radio, telephone or other forms of electronic communication.

A VTG represents interoperability of a group of channels. A VTG may include an associated virtual channel and an ID. Virtual channels may comprise an address, such as an IP address, associated with a VTG through which endpoints may access the VTG and/or through which communications from VTG member-endpoints are bridged. Various types of VTGs may be utilized in particular embodiments, such as a multicast address usable by all endpoints of the VTG, a VTG comprising multiple talk groups (e.g., multiple radio sources from different frequencies whose communications are mixed), a unicast group and a combination unicast and multicast group.

As an example, a particular VTG may facilitate communications between the following endpoints: (1) one or more airplanes using a unique communication channel associated therewith, (2) several endpoints of a particular functional group within the airport (e.g., security, taxiing) using a unique communication channel associated with their respective functional group, (3) one of more dispatchers using IP-enabled endpoints such as IP-enabled PCs and (4) one or more airport administrators using a plain old telephone (POTs) such as a cell phone or a time-division multiplexed (TDM) phone. A dispatcher of IS 50 having administrative privileges may configure the VTG using any suitable interface, such as by dragging and dropping the included channels and IP endpoints into a single area representing the VTG. The IS may itself configure the VTG, such as by including endpoints within a geographical area associated with a particular function. For example, those endpoints within 100 feet of a particular gate and associated with baggage handling may be added to a VTG for an airplane that needs to be loaded for a flight at the gate. Regardless of how the VTG is initially configured, during the life of the VTG the various users comprising the VTG may change as the individual endpoints change location or function.

MCS 56 may provide the functionality used in facilitating the communications of the VTG members. In particular embodiments, multiple talk groups may be patched together on a dynamic (either automated or manual), as needed basis. In some cases a VTG may not necessarily include communications through an IS but may instead include member endpoints whose communications are mapped to IP addresses at gateways (such as LMR gateways) controlled by an IS.

Any number of VTGs may be configured to provide any suitable audio, data, video and control network interoperability. VTGs may be created using any suitable user/endpoint groups or channels based on location, organizational requirements, event requirements or any other suitable characteristic. An administrator or operator may configure channel details such as name, description, participants, multicast IP addresses, codec and latch options through, for example, OMA 54.

It will be recognized by those of ordinary skill in the art that endpoints and interoperability systems disclosed herein are merely example configurations in accordance with particular embodiments. These systems may include any number of interfaces, processors, memory modules, and other components to accomplish the functionality and features described herein. In addition, these components and other desired components for performing the above described functionality may be centrally located (local) with respect to one another, or distributed throughout communication systems and networks. In addition, one or more components of these systems and devices may work together in performing various functionality described herein.

FIG. 3 illustrates an example airport in which interoperability system 50 may be used, in accordance with a particular embodiment. Within airport 400 is airplane 450 which has been depicted in four different locations (450a-450d). These four different locations mark the different locations airplane 450 may be in as it progresses through the various stages of launching a flight. Thus, airplanes 450a-450d represent airplane 450 at four different times. In particular embodiments some endpoints within airport 400 may be associated with a particular task or share a common function. For example, endpoints 446 and 448 may be responsible for loading luggage into an airplane, while endpoint 445 may be responsible for getting the airplanes to their correct takeoff position. While the function of some of the endpoints within the airport may remain the same, the function of other endpoints within the airport may change over time. For example, airplane 450 may start at the gate (450a) and then once the passengers have boarded the plane may taxi (450b) to a runway for takeoff (450c) and then be up and flying (450d). Through the IS the endpoints sharing a common function may communicate with one another using their own communication network or channel, even if not all of the endpoints are using the same communication channel or technology.

As mentioned above, as airplane 450 progresses through the various stages of launching a flight (e.g., 450a-450d) its function, state and/or required services may change. This change in function may correspond to a change in the communications requirements of airplane 450 and thus may require communication with different sets of endpoints. While it may be that the pilot could talk to the different sets of endpoints if all the endpoints used the same communication channel, doing so would likely make it nearly impossible to decipher intelligible words from amongst all the other chatter. This is partly why airports currently use different communication channels for different sets of endpoints. Unfortunately, this currently requires the pilot to have to constantly change his communication channel so that he may communicate with those endpoints associated with the airplane's changing function or functional needs, such as gate functionality, taxiing functionality, take-off functionality and flight functionality. Thus, in existing communication networks, while the pilot is changing his communication channel he is temporarily unable to communicate with those endpoints with which he needs to be able to communicate.

In particular embodiments, functionally related endpoints may be part of a VTG. The airport depicted in FIG. 3, for simplicity, shows airplane 450 at four different stages of a flight: (1) airplane 450a may be airplane 450 at a pre-flight or loading stage, (2) airplane 450b may be airplane 450 at a taxiing stage, (3) airplane 450c may be airplane 450 at a take-off stage, and (4) airplane 450d may be airplane 450 at a flight stage. Other embodiments may have fewer or more stages, such as a landing stage or a post-flight stage, depending on the needs of the airport. It should also be pointed out that the present invention is not limited to just airports but may be used in any situation in which there are some endpoints that perform similar functions for an extended period of time and some endpoints whose location, state, function and/or functional requirements may change over time. For example, a dock or port may have some endpoints that load ships, some endpoints that unload ships, and then the ships themselves which may go from being unloaded to loaded (or vice-versa).

The following example is designed to illustrate some of the features and elements of particular embodiments. The example will follow airplane 450 as it progresses through the different stages of launching a flight. Initially airplane 450a will be at terminal 410 where various preflight preparations may be performed, the luggage loaded, and the passengers boarded. At this initial stage airplane 450a may be part of a VTG associated therewith. Along with airplane 450a, this particular VTG, airplane 450's VTG, may include baggage handler 446 and a gate dispatcher who may be within terminal 410 or control tower 420. Other airplanes (e.g., 440 and 441) that are preparing for a flight may similarly have their own VTGs with their own endpoints associated therewith (e.g., baggage handlers 447 and 448 may be associated with the VTG associated with airplane 441).

The gate dispatcher may be in charge of directing traffic among the various endpoints within the various VTGs associated with different gates of the airport. Furthermore, the gate dispatcher may add or remove endpoints (including himself or other dispatchers/controllers) to or from the VTG associated with, for example, airplane 450 depending on the particular needs of airplane 450, and the particular functions the endpoint may provide. For example, when airplane 450a is ready to begin loading or performing pre-flight preparations the gate dispatcher may create a VTG for airplane 450a. The gate dispatcher may add those endpoints, for example baggage handlers 447 and 448, which may be servicing airplane 450a to airplane 450's VTG. In some embodiments, the IS may automatically add necessary or required endpoints based on airplane 450's current (or impending) functional needs and/or location.

Similarly, once airplane 450a is ready to depart, the gate dispatcher may add a taxiing dispatcher to airplane 450's VTG (airplane 450a may now be referred to as airplane 450b). The taxing dispatcher may then remove the gate dispatcher and add any additional endpoints that may be needed to taxi airplane 450b to its take-off position. This may be done via the IS which, in some embodiments, may provide a dispatcher with a drag-and-drop interface through which the various dispatchers or controllers are able to add and remove different endpoints to and from airplane 450's VTG. As long as the airplane remains in his VTG the pilot is able to conduct his flight without having to adjust his communication device. This is because a dispatcher or controller may simply add to airplane 450's VTG those endpoints with which airplane 450 may need to communicate.

In particular embodiments, airplane 450 may initially need to set his communication device to a particular communication channel associated therewith; the communication channel may be a channel unique to that airplane. Furthermore, in order to facilitate adding and removing endpoints from airplane 450's VTG, airplane 450 may include a gateway, such as an LMR gateway, that may allow airplane 450's radio to function as an IP endpoint. This may allow airplane 450 to conduct its entire flight, from loading/boarding to unloading/de-boarding, without the pilot of airplane 450 having to adjust his communication device. This may be because, the dispatcher or controller may use the functionality of an IS to patch into the VTG associated with airplane 450 those endpoints with which airplane 450 needs to communicate.

In some embodiments airplane 450 may initially need to manually set his communication device to the appropriate communication channel. For example, the pilot may have to turn a dial or press a button to set the endpoint to the correct communication channel. Then, once his communication channel has been set, he may not have to adjust it again for the duration of the flight. In some embodiments the communication device may automatically set itself to the appropriate communication channel. For example, airplane 450 may receive a message from the IS that contains information and/or instructions detailing the proper communication channel for airplane 450. Thus, airplane 450 may never need to adjust his communication device.

Among those embodiments in which airplane 450's communication device is automatically set (without any intervention by the pilot) there may be some embodiments in which the message that may cause the communication device to be set to the appropriate communication channel is sent by a third person (e.g., a dispatcher or controller). For example, airplane 450's communication device may be linked to the IS such that a dispatcher/controller may initially set-up the communication channel of airplane 440 via the IS. In particular embodiments, the communication channel of airplane 450 may initially be set by the IS. For example, airplane 450's communication device may be linked to the IS such that when the IS detects (through any of a variety of sensors) that airplane 450 is ready to begin preparing for its flight, it may send the message that initially causes airplane 450's communication device to be set.

The level of control a dispatcher has over a particular VTG may depend on the VTG to which the dispatcher is assigned. In some embodiments a dispatcher may only be able to control the resources of the VTG to which he is initially assigned. As will be seen later, in particular embodiments a dispatcher assigned to a particular VTG may not remove himself from that VTG until a second dispatcher is added to the VTG. Upon the second dispatcher being added, the first dispatcher may remove himself from the VTG. The second dispatcher may be responsible for the next stage of the flight. In some embodiments, the first dispatcher may not be able to remove himself but rather may need to wait for the second dispatcher (that has been added to the particular VTG) to remove the first dispatcher. This may act as a safety mechanism to help prevent airplane 450 from ever being out of communication with at least one dispatcher.

For as long as airplane 450a is tuned into the communication channel or particular airplane VTG associated therewith he may be able to communicate with the other endpoints associated with airplane 450's VTG. An IS, such as IS 50 depicted in FIG. 2, may be used to enable (from the individual users perspective) the various different communication channels of the endpoints within airplane 450's VTG to be used as though they were the same communication channel. For example, airplane 450a, associated with airplane 450's VTG, may use a communication channel, such as a particular RF channel, which may be different than the communication channel used by baggage handler 446. Furthermore, the VTG and/or communication channel associated with airplane 450 may be different than the VTG and/or communication channel associated with airplane 441, which may be different than the communication channel used by baggage handler 448. Accordingly, the IS may, for example, receive a communication from airplane 450 and then re-transmit the communication to all the other endpoints within airplane 450's VTG using each endpoints' own respective communication channel. In some embodiments in which a VTG may include multiple IP endpoints, communications may be sent using multicast or unicast.

After airplane 450a has finished whatever functions it requires at terminal 410 it may transition to the taxiing stage where it will now be referred to as airplane 450b. At some point a taxiing dispatcher may be added to airplane 450's VTG. This may be done by the gate dispatcher or the IS (where the IS is aware of airplane 450b's current state or position, for example, through GPS information supplied by airplane 450b) adding the taxiing dispatcher to airplane 450's VTG. The timing of this transfer may vary depending on several different factors, such as the airport's operating procedures, the dispatcher's speed or efficiency, and/or the level of congestion of the airport. Just as the taxiing dispatcher may be added to airplane 450's VTG, so too may the gate dispatcher be removed (after the taxiing dispatcher has been successfully added to airplane 450's VTG for some amount of time). Besides the taxiing dispatcher, the IS (or the taxiing dispatcher) may add other airplanes, such as airplanes 442 and 443 as well as other endpoints such as truck 445, to airplane 450's VTG depending on the situation and needs of airplane 450b. These endpoints may be added to airplane 450's VTG automatically by the IS or manually by the taxiing dispatcher. Once added, these endpoints may be able to communicate with all the other endpoints within airplane 450's VTG as though they were using the same communication channel.

The transition of airplane 450 from the loading/preflight stage to the taxing stage may be performed in a variety of different ways. The different ways may generally be designed to avoid communication blackout periods that often plague existing communication systems in which airplane 450b is unable to communicate with other endpoints as he changes his radio frequency. In some embodiments the taxiing dispatcher may be added to airplane 450's VTG when airplane 450b is within a particular area of the airport (e.g., when airplane 450b is within 100 yards of a runway). In some embodiments, airplane 450b may communicate his location parameter to the IS via, for example, GPS information so that the IS is aware of the airplane's location. In some embodiments the IS may be aware of airplane 450's location based on input from various sensors located around the airport. Once airplane 450b is out of the area associated with the gate and/or in the area associated with taxiing, the taxiing dispatcher may be added to airplane 450's VTG by the IS. Similarly, the IS may add to airplane 450's VTG other endpoints (e.g., truck 445) with which airplane 450b may need or want to communicate. Furthermore, endpoints whose services are no longer required or needed by airplane 450b may be removed from airplane 450's VTG by similar means.

Particular embodiments may add or remove endpoints (including dispatchers and controllers) by dispatcher action. For example, once airplane 450b has finished its required loading functions at terminal 410 the gate dispatcher may add the taxiing dispatcher to airplane 450's VTG. For example, the gate dispatcher may have a graphical user interface (GUI) that displays the available VTGs associated with various airplanes within the airport's airspace (including those that are on the ground within the airport) and the various endpoints associated with the airport. The GUI may also display which endpoints are currently assigned to which VTGs. The gate dispatcher may then select an available endpoint, such as another dispatcher or a baggage handler, using, for example a drag and drop function to add that endpoint to airplane 450's VTG once airplane 450b is ready to begin the taxiing stage.

In some embodiments the gate dispatcher and the taxiing dispatcher may both be in airplane 450's VTG at the same time. They may both remain in the VTG for a predetermined amount of time as a safeguard to prevent airplane 450b from being out of contact with a dispatcher. By not immediately removing the gate dispatcher from airplane 450's VTG, airplane 450b may, for example, be able to alert the gate dispatcher that airplane 450b is not able to communicate with the taxiing dispatcher even though airplane 450b is within the area associated with taxiing. In some embodiments the gate dispatcher may remain in airplane 450's VTG with the taxiing dispatcher until the gate dispatcher is removed, for example by the taxiing dispatcher. Some embodiments may provide a safeguard feature that ensures the gate dispatcher cannot take himself out of airplane 450's VTG. Rather, the gate dispatcher may have to wait for the taxiing dispatcher to remove the gate dispatcher. This creates a closed-loop communication system that helps to ensure that airplane 450b remains in contact with at least one dispatcher as airplane 450b progress through the various stages of his flight for a seamless hand-off of airplane 450b from the gate stage to the taxiing stage. A similar process may be used in transitioning airplane 450 between any other stages of the flight (e.g., different airspaces along the flight path).

In some embodiments the IS may provide a warning or notice to the gate dispatcher informing him that airplane 450b needs, or will soon need, to be able to communicate with the taxiing dispatcher. Similarly, the IS may provide a warning to the taxiing dispatcher to provide him with notice that he is about to be able to communicate with airplane 450b. The IS may further alert airplane 450b, providing him with notice that he is about to transition from the preflight stage to the taxiing stage and that there may be a change in the endpoints with which airplane 450b may communicate. Any of the endpoints being added, removed or transitioned may, upon hearing the warning or notice, cancel or override the change. This may be done manually or via the IS. For example, airplane 450b may send a request to the gate dispatcher not to make the change, or airplane 450b may manually change his communication device.

When the gate dispatcher adds the taxiing dispatcher to airplane 450's VTG, the gate dispatcher may have to wait a predetermined amount of time before he can remove himself. In some embodiments the IS may wait to verify that the taxiing dispatcher is associated with airplane 450's VTG before the IS will allow the gate dispatcher to remove himself, or the IS may remove the gate dispatcher from airplane 450's VTG after verifying that the taxiing dispatcher has been added to airplane 450's VTG. In particular embodiments, the gate dispatcher may have to wait for the taxiing dispatcher to remove the gate dispatcher. This overlap between dispatchers may help to prevent isolating airplane 450 from the dispatchers.

Regardless of whether a dispatcher or the IS system adds endpoints into airplane 450's VTG, the result from the pilot's perspective is the same. The pilot does not have to make any changes to his communication device (e.g., he doesn't have to change his communication channel). Rather, by adding endpoints to airplane 450's VTG the communication channel associated with those endpoints is patched into airplane 450's VTG. This allows airplane 450b to communicate with the other endpoints of airplane 450's VTG as though they were all using the same communication channel. Furthermore, by associating a communication channel with an endpoint and then adding or removing that communication channel to different VTGs, the IS's functionality may be implemented without having to make modifications to existing communication devices of the airplane or the various controllers/dispatchers.

The transition between taxiing and take-off and then between take-off and flight may be accomplished in a way similar to the transition between preflight (functions and service performed at the gate) and taxiing. Accordingly, after airplane 450b has finished taxiing and is ready to take-off a take-off controller may be added to airplane 450's VTG (airplane 450b may now be referred to as airplane 450c). The taxiing dispatcher may subsequently be removed from airplane 450's VTG in accordance with any of the procedures described above with respect to removing the gate dispatcher. Once the take-off controller has been added to airplane 450's VTG, the take-off controller may add to the VTG any other endpoints that may be needed by airplane 450c to allow airplane 450c to communicate with these other endpoints as well as the take-off controller as though they were using the same communication channel, even though they may each be using a different communication channel.

Similarly, after airplane 450c has finished taking off and is actually flying, an air traffic controller may be added to airplane 450's VTG (now referred to as airplane 450d). The take-off controller may subsequently be removed from airplane 450's VTG in accordance with any of the procedures described above with respect to removing the gate dispatcher. Once the air traffic controller has been added to airplane 450's VTG the air traffic controller may be able to add any other endpoints with which airplane 450d may want to communicate. Thus, airplane 450d is able to communicate with these other endpoints as well as the air-traffic controller as though they were using the same communication channel, even though they may each be using a different communication channel.

Not depicted in FIG. 3 are other airports and other air traffic control towers. By using the methods described above, airplane 450 is able to transition between different air spaces controlled by different air traffic controllers, without having to continuously adjust his communication device. This further avoids communication blackout periods common in existing communication systems when the pilot adjusts his radio between airspaces.

As mentioned above particular embodiments may transmit a notification to airplane 450 to let it know when it is about to be transitioned to a new dispatcher or controller. This notification, as well as the one provided to any dispatchers, may be audible (e.g., an alarm tone or spoken voice), textual (e.g., instant message) or any other type of indication (e.g., a blinking light) sufficient to alert the user of the endpoint.

It should be noted that while the endpoints of some embodiments may utilize new communication devices, the functionality of the present invention can be implemented using existing communication devices (e.g., the LMR already installed in an airplane). Furthermore, the present invention is not limited to LMRs or only those endpoints associated with a particular VTG. The IS may, if needed, be used to patch other endpoints into airplane 450's VTG. For example, the IS may patch a PSTN phone to communicate with a LMR endpoint within airplane 450's VTG. Furthermore, endpoints from other airport agencies (not directly associated with preparing for and launching a flight), such as local police or fire authorities, may be patched to airplane 450's VTG. This provides for simpler and more efficient communication between different endpoints in an emergency situation. The IS may also be used beyond a single location (e.g., a single airport). For example, functionality similar to that which was described above with respect to transferring an airplane between different functional VTGs within an airport, may be used to transfer an airplane between different regional air traffic control areas during the airplanes flight.

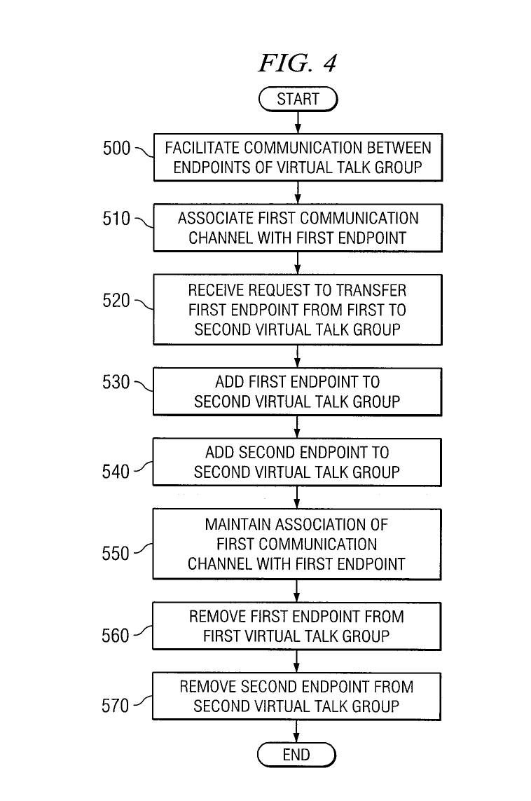

FIG. 4 illustrates a method for managing a plurality of virtual talk groups. The illustrated method allows, among other things, an endpoint to be transferred between VTGs without having to adjust his own communication device. The method begins at step 500 where a first VTG is formed. The first VTG may be associated with a first endpoint, such as an airplane or cargo ship, and include at least the first endpoint and a second endpoint, such as a dispatcher, controller or operator. The second endpoint may be associated with a particular function, such as controlling air traffic in the airspace around an airport or overseeing the loading of airplanes. The first VTG may include other endpoints added to the first VTG either automatically (e.g., an IS adds certain endpoints based on the function associated with the endpoint) or manually by another endpoint (e.g., by a dispatcher). All, some, or none of the endpoints within the first VTG may be using different communication methods (e.g., different communication devices or channels).

As part of the first VTG, the endpoints therein are able to communicate with one another as though they were using the same type of communication device on the same communication channel. This is because at step 510, the IS facilitates communications between endpoints of the first VTG. The IS may support several VTGs where each VTG may be associated with a particular endpoint (e.g., each plane at an airport may have its own VTG), area (e.g., train depot or San Jose airspace) or function (e.g., local police or airport security). The endpoints within a VTG may use the same or different communication channels; different communication channels may include different communication technologies, such as POTS phones or LMRs, or channels using the same technology, for example LMRs using different frequencies.

Some endpoints within a VTG may change their function or location over time. For example, the first endpoint may be an airplane that upon finishing boarding may begin to taxi. Not only may these endpoint have a VTG associated with them, but they may also have a communication channel associated with them. For example, the first endpoint may have a first communication channel associated therewith. In some embodiments the first communication channel associated with the first endpoint may be different than the communication channels used by other endpoints within the VTG. Even though the first endpoint may be using a different communication channel it is still able to communicate with the other endpoints within the VTG through the IS.

At step 520 the IS may receive a request to add a third endpoint to the first VTG. The third endpoint may be associated with a function different than the function associated with the second endpoint. The function with which the third endpoint is associated may be the next function needed by the first endpoint. The request to add the third endpoint may be received from an endpoint within the first VTG (e.g., the second endpoint) or from within the IS. The request may be based on, for example, the first endpoint's location, state and/or functional need. Where the request is based on the first endpoint's location the first endpoint's location may be determined, for example, from GPS information transmitted by the first endpoint, information entered by a dispatcher based on what they observe, a report or update provided by the user of the first endpoint, or readings from a sensor (e.g., radar, motion detector, RFID, weight sensor or any other device that may be used to detect the presence of an endpoint). Where the request is based on the first endpoint's desired function, the first endpoint's desired function may, for example, be determined from information provided by the user of the first endpoint, from observations of a dispatcher, or devices such as timers, clocks, fluid or material level indicators or any other device that may be used to determine the status of some feature of, or related to, the first endpoint. The IS or a dispatcher may use the information from any of the above sources to determine the airplane's current (or next) stage. This information may then be used to determine when to add the third endpoint to the first VTG, when the second endpoint needs to be removed from the first VTG and/or when to add or remove additional endpoints (and which endpoints to add or remove) as will be discussed below.

Once the IS has received the request to add the third endpoint to the first VTG at step 520, the IS may generate an alert at step 530. The alert may be sent to: the first endpoint, providing him with notice that the endpoints with which he is able to communicate are about to change; the second endpoint, providing him with notice that he is about to be removed from the first VTG; the third endpoint, providing him with notice that he is about to be added to the first VTG; and/or any other endpoints that may be added or removed from the first VTG. The alert may be sent at any desirable time prior to steps 540 (adding endpoints) and 550 (removing endpoints).

At step 540 at least the third endpoint is added to the first VTG. By adding the third endpoint to the first VTG, the IS enables, through for example multicast, the third endpoint to communicate with the other endpoints of the first VTG as though they were using the same communication channel. Thus, the first, second and third endpoints are able to communicate with one another. This may be done without the first endpoint having to make any adjustments to his communication device (e.g., tuning his radio). At step 540, either concurrently with or shortly after adding the third endpoint to the first VTG, the IS may add any additional endpoints that may be needed or desired to the first VTG. The additional endpoints may be endpoints that are responsible for performing certain services for the first endpoint. For example, the first endpoint may be an airplane and the additional endpoints may be responsible for loading the luggage into the airplane. These additional endpoints may be added to the airplane's VTG automatically as the airplane's location changes.

The third endpoint may have the ability to change which endpoints are part of the first VTG or he may be in contact with someone who can. In some embodiments, the third endpoint may be a dispatcher or a controller or the third endpoint may be in the same room or building as a dispatcher or a controller. Having both the second and third endpoints (both of whom may be dispatchers) in the first VTG may be done as a precautionary measure. This may prevent, for example, the accidental or unintentional radio isolation of the first endpoint. For example, if the third endpoint is not added properly to the first VTG or is unable to communicate with the endpoints therein there is still someone (the second endpoint) in the VTG that can communicate with the first endpoint and control the membership of the first VTG. Nothing in this method prevents the pilot, as a fall back, from manually adjusting his radio to any needed frequency.

At step 550 at least the second endpoint is removed from the first VTG after a certain amount of time. Thus, as mentioned above, there is a certain amount of time in which the first endpoint is able to communicate with both the second and third endpoints. The amount of time both endpoints spend in the first VTG may be a fixed, predetermined amount of time (e.g., 3 minutes), it may be whatever amount of time the second and/or third endpoints need to ensure that the first and third endpoints are able to communicate, or it may be whatever amount of time the IS needs to confirm that that the third endpoint has been properly added to the first VTG (e.g., by verifying that first and third endpoints have each exchanged at least one communication). Similarly, at step 550, any additional endpoints (e.g., baggage handlers) that were associated with the first endpoint's first function may be removed. These additional endpoints may be removed at the same time the second endpoint is removed, or they may be removed at a different time.

During the addition of the third endpoint and the removal of the second endpoint, the IS maintains the association of the first communication channel with the first endpoint, shown in step 560. This allows the user of the first endpoint to focus on the actual task they are performing instead of having to adjust their communication device to the correct communication channel. This helps to avoid radio blackouts that may exist while the pilot is adjusting his communication device. In some embodiments, the IS may automatically cause the communication device of the endpoint to change to the communication channel associated with the airplane or its VTG.

As in other embodiments, a VTG may comprise endpoints utilizing different technologies. In particular embodiments, at least some of the endpoints may communicate through PTT technology. In addition, some of the endpoints may comprise IP endpoints. Moreover, the different communication networks may comprise networks of various functional groups within an airport, whether public or private as well as networks of public and private groups, companies or organizations.

Some of the steps illustrated in FIG. 4 may be combined, modified or deleted where appropriate, and additional steps may also be added to the flowchart. Additionally, steps may be performed in any suitable order without departing from the scope of the invention.

While various implementations and features are discussed with respect to multiple embodiments, it should be understood that such implementations and features may be combined in various embodiments. For example, features and functionality discussed with respect to a particular figure such as FIG. 3 may be used in connection with features and functionality discussed with respect to another such figure according to operational needs or desires.

Although the present invention has been described in detail with reference to particular embodiments, it should be understood that various other changes, substitutions, and alterations may be made hereto without departing from the spirit and scope of the present invention. For example, although the present invention has been described with reference to a number of elements included within communication system 10 and illustrated endpoints and interoperability systems, these elements may be combined, rearranged or positioned in order to accommodate particular routing architectures or needs. In addition, any of these elements may be provided as separate external components to communication system 10 and illustrated endpoints and interoperability systems, or each other where appropriate. The present invention contemplates great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims.

What is claimed is:

1. A method for managing a plurality of virtual talk groups, comprising:
forming a first virtual talk group associated with a first endpoint, the first virtual talk group comprising the first endpoint and a second endpoint, the second endpoint associated with a first function;
facilitating communications between the endpoints of the first virtual talk group;
upon a change in a function of the first endpoint from the first function to a second function, receiving a request to add a third endpoint to the first virtual talk group, the third endpoint associated with the second function;
adding the third endpoint to the first virtual talk group; and
removing the second endpoint from the first virtual talk group after the third endpoint has been added to the first virtual talk group for a first amount of time.

2. The method of claim 1, wherein facilitating communications between the endpoints of the first virtual talk group comprises facilitating communications of the first virtual talk group to the first endpoint through a first communication channel associated with the first endpoint.

3. The method of claim 1, wherein the request to add the third endpoint to the first virtual talk group is received from the second endpoint.

4. The method of claim 1, wherein removing the second endpoint from the first virtual talk group after the third endpoint has been added to the first virtual talk group for a first amount of time comprises receiving from the third endpoint a request to remove the second endpoint from the first virtual talk group.

5. The method of claim 1, wherein the first endpoint comprises a pilot of an airplane, the second endpoint comprises an airport dispatcher and the third endpoint comprises an air traffic controller.

6. The method of claim 1, wherein receiving a request to add a third endpoint to the first virtual talk group comprises receiving a change in a location parameter of the first endpoint, the change in the location parameter of the first endpoint corresponding to the change in the function of the first endpoint.

7. The method of claim 1, further comprising alerting the first endpoint that the third endpoint will be added to the first virtual talk group and that the second endpoint will be removed from the first virtual talk group.

8. A system for managing a plurality of virtual talk groups, comprising:
a processor operable to:
form a first virtual talk group associated with a first endpoint, the first virtual talk group comprising the first endpoint and a second endpoint, the second endpoint associated with a first function; and
facilitate communications between the endpoints of the first virtual talk group; and
an interface coupled to the processor and operable to:
upon a change in a function of the first endpoint from the first function to a second function, receive a request to add a third endpoint to the first virtual talk group, the third endpoint associated with the second function;
wherein the processor is further operable to:
add the third endpoint to the first virtual talk group; and
remove the second endpoint from the first virtual talk group after the third endpoint has been added to the first virtual talk group for a first amount of time.

9. The system of claim 8, wherein the processor operable to facilitate communications between the endpoints of the first virtual talk group comprises a processor operable to facilitate communications of the first virtual talk group to the first endpoint through a first communication channel associated with the first endpoint.

10. The system of claim 8, wherein the request to add the third endpoint to the first virtual talk group is received from the second endpoint.

11. The system of claim 8, wherein the processor operable to remove the second endpoint from the first virtual talk group after the third endpoint has been added to the first virtual talk group for a first amount of time comprises a processor operable to remove the second endpoint from the first virtual talk group after the receipt by the interface of a request from the third endpoint to remove the second endpoint from the first virtual talk group.

12. The system of claim 8, wherein the first endpoint comprises a pilot of an airplane, the second endpoint comprises an airport dispatcher and the third endpoint comprises an air traffic controller.

13. The system of claim 8, wherein the interface operable to receive a request to add a third endpoint to the first virtual talk group comprises an interface operable to receive a change in a location parameter of the first endpoint, the change in the location parameter of the first endpoint corresponding to the change in the function of the first endpoint.

14. The system of claim 8, wherein the processor is further operable to alert the first endpoint that the third endpoint will be added to the first virtual talk group and that the second endpoint will be removed from the first virtual talk group.

15. Logic embodied in a computer readable medium, the computer readable medium comprising code operable to:
form a first virtual talk group associated with a first endpoint, the first virtual talk group comprising the first endpoint and a second endpoint, the second endpoint associated with a first function;
facilitate communications between the endpoints of the first virtual talk group;
upon a change in a function of the first endpoint from the first function to a second function, receive a request to add a third endpoint to the first virtual talk group, the third endpoint associated with the second function;
add the third endpoint to the first virtual talk group; and
remove the second endpoint from the first virtual talk group after the third endpoint has been added to the first virtual talk group for a first amount of time.

16. The medium of claim 15, wherein the code operable to facilitate communications between the endpoints of the first virtual talk group comprises code operable to facilitate communications of the first virtual talk group to the first endpoint through a first communication channel associated with the first endpoint.

17. The medium of claim 15, wherein the request to add the third endpoint to the first virtual talk group is received from the second endpoint.

18. The medium of claim 15, wherein the code operable to remove the second endpoint from the first virtual talk group after the third endpoint has been added to the first virtual talk group for a first amount of time comprises code operable to receive from the third endpoint a request to remove the second endpoint from the first virtual talk group.

19. The medium of claim 15, wherein the first endpoint comprises a pilot of an airplane, the second endpoint comprises an airport dispatcher and the third endpoint comprises an air traffic controller.

20. The medium of claim 15, wherein the code operable to receive a request to add a third endpoint to the first virtual talk group comprises code operable to receive a change in a location parameter of the first endpoint, the change in the location parameter of the first endpoint corresponding to the change in the function of the first endpoint.

21. The medium of claim 15, wherein the code is further operable to alert the first endpoint that the third endpoint will be added to the first virtual talk group and that the second endpoint will be removed from the first virtual talk group.

22. A system for managing a plurality of virtual talk groups, comprising:
means for forming a first virtual talk group associated with a first endpoint, the first virtual talk group comprising the first endpoint and a second endpoint, the second endpoint associated with a first function;
means for facilitating communications between the endpoints of the first virtual talk group;
means for, upon a change in a function of the first endpoint from the first function to a second function, receiving a request to add a third endpoint to the first virtual talk group, the third endpoint associated with the second function;
means for adding the third endpoint to the first virtual talk group; and
means for removing the second endpoint from the first virtual talk group after the third endpoint has been added to the first virtual talk group for a first amount of time.
